(19) United States
(12) Patent Application Publication
(10) Pub. No.: US 2008/0223472 A1
(43) Pub. Date: Sep. 18, 2008

(54) Flexible hose and vacuum cleaner having the same

(75) Inventors: Kyong-hui Jeon, Seosan-si (KR); Hwa-gyu Song, Gwangju-city (KR); Sung-cheol Lee, Seoul (KR)

Correspondence Address: BLANK ROME LLP, 600 NEW HAMPSHIRE AVENUE, N.W., WASHINGTON, DC, 20037, US

(73) Assignee: Samsung Gwangju Electronics Co., Ltd.

(21) Appl. No.: 11/905,621

(22) Filed: Oct. 2, 2007

(30) Foreign Application Priority Data
Mar. 12, 2007 (KR) 2007-23963

(51) Int. Cl. F16L 11/11; A47L 9/32

(52) U.S. Cl. 138/121; 15/351; 138/122; 138/129

(57) ABSTRACT

A flexible hose includes a bellows pipe wall and an air barrier. The bellows pipe wall includes peaks defined on an outer surface of the bellows pipe wall, valleys is adjacent a respective peak, and grooves defined on an inner surface of the bellows pipe wall. Each groove is under a respective peak. The air barrier is near each of the grooves to prevent air from entering the grooves.

### CROSS-REFERENCE TO RELATED APPLICATION

This application claims priority under 35 U.S.C. §119 from Korean Patent Application No. 10-2007-0023963, filed on Mar. 12, 2007, in the Korean Intellectual Property Office, the disclosure of which is incorporated herein by reference in its entirety.

### FIELD OF THE INVENTION

The present invention relates to a flexible hose for a vacuum cleaner. In particular, the present invention relates to a flexible hose for use with a vacuum cleaner in which flow noise is reduced.

### BACKGROUND OF THE INVENTION

A conventional vacuum cleaner cleans by using a suction source and a suction port assembly which contacts a surface to be cleaned. By using suction, the conventional vacuum cleaner draws in air and dust from the surface to be cleaned. Then, the conventional vacuum cleaner separates dust from the drawn-in air in a dust separating device housed in the vacuum cleaner and discharges the air outside of the vacuum cleaner. The term “dust” will be used hereinafter to collectively refer to dust, dirt, particulates, and other similar materials.

A conventional vacuum cleaner generally includes the suction port assembly to draw in dust, a handle to operate the vacuum cleaner, an extension pipe to connect the suction port assembly with the handle, a flexible hose to connect the handle with a main body, and the main body. The conventional flexible hose provides an air passageway through which external air containing dust flows from the suction port assembly to the dust separating device in the main body through the extension pipe. The flexible hose is typically made of soft synthetic resin to enhance pliability so that a user can easily manipulate the suction port assembly.

Referring to FIG. 1, the conventional flexible hose 1 is shown with air containing dust flowing in a direction B. The conventional flexible hose 1 has a bellows pipe wall 2 with a plurality of grooves 3 disposed at the pipe wall 2. Thus, when air containing dust flows in the bellows pipe wall 2, a portion of the air collides with the plurality of grooves 3 in the bellows pipe wall, and as a result, flow noise increases.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. The present invention provides a flexible hose in which flow noise is reduced.

One embodiment of the present invention provides a flexible hose. The flexible hose includes a bellows pipe wall, the bellows pipe wall including, a plurality of peaks defined on an outer surface of the bellows pipe wall, a plurality of valleys, each of the plurality of valleys being disposed adjacent a respective peak, and a plurality of grooves defined on an inner surface of the bellows pipe wall, each of the plurality of grooves being disposed under a respective peak; and an air barrier disposed near each of the plurality of grooves configured to prevent air from entering the plurality of grooves.

Another embodiment of the present invention provides a vacuum cleaner. The vacuum cleaner includes a suction port assembly for suctioning in air; a flexible hose with a first end and a second end, the first end being in fluid communication with the suction port assembly, the flexible hose including, a wall surrounding the air flowing through the flexible hose, at least one peak disposed at an outer surface of the wall, at least one valley disposed adjacent to the at least one peak at the wall, at least one groove disposed at an inner surface of the wall under the at least one peak, and an air barrier configured to prevent air from entering the at least one groove; and a main body being in fluid communication with the second end of the flexible hose.

Yet another embodiment of the present invention provides a flexible hose. The flexible hose includes a wall surrounding a fluid flowing through the flexible hose; at least one peak disposed at an outer surface of the wall; at least one valley disposed adjacent the at least one peak at the outer surface of the wall; at least one groove disposed at the inner surface of the wall under the at least one peak; and an air barrier including, a first ledge disposed adjacent to the at least one groove, the first ledge extending over the at least one groove in a direction substantially opposite to the flow direction, the first ledge partially covering the at least one groove, and a second ledge disposed adjacent to the at least one groove opposite the first ledge, the second ledge extending over the at least one groove in a direction substantially parallel to the flow direction, the second ledge partially covering the at least one groove, the second ledge partially overlapping the first ledge, wherein the first ledge and the second ledge cover the at least one groove completely preventing the fluid flowing through the flexible hose from entering the at least one groove.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a side elevational view in section of a conventional flexible hose;

FIG. 2 is a perspective view of a vacuum cleaner with a flexible hose according to an exemplary embodiment of the present invention;

FIG. 3 is a perspective view of portion A of the flexible hose illustrated in FIG. 2;

FIG. 4 is a side elevational view in section of the flexible hose illustrated in FIG. 2; and

FIG. 5 is a graph illustrating a reduction in noise by the flexible hose according to an exemplary embodiment of the present invention.

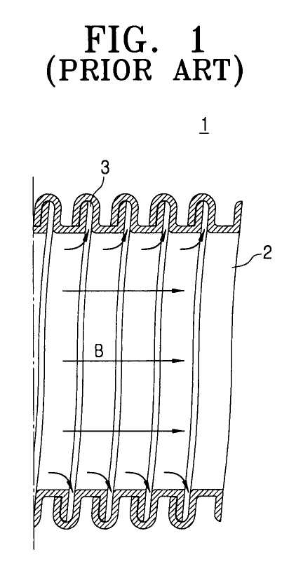

### DETAILED DESCRIPTION OF THE EXEMPLARY EMBODIMENTS

Certain exemplary embodiments of the present invention will now be described in greater detail with reference to the accompanying drawings.

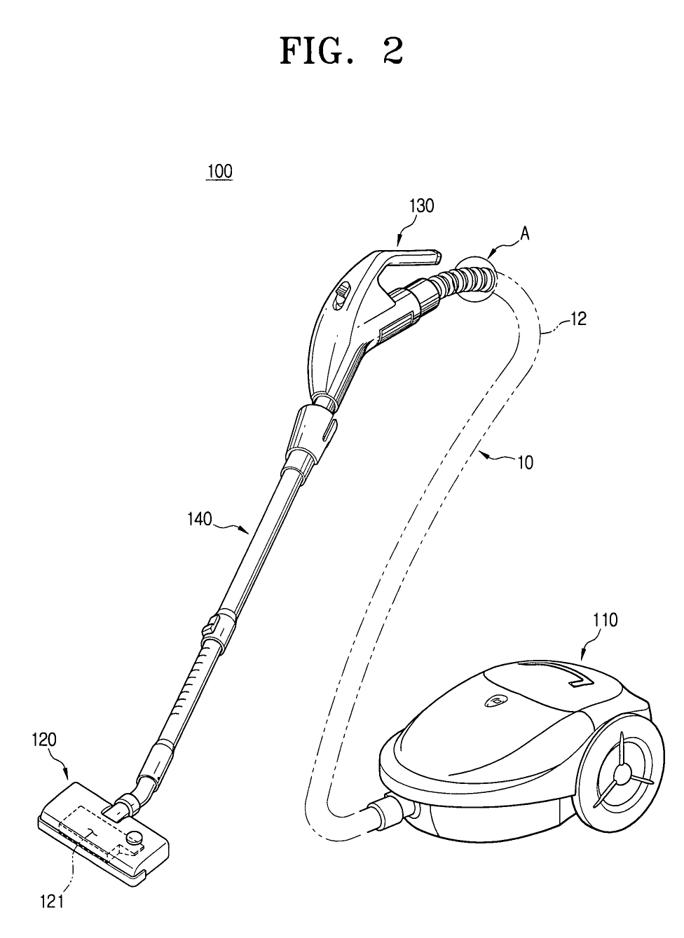

Referring to FIG. 2, a vacuum cleaner 100 employing a flexible hose 10 may include a suction port assembly 120, an extension pipe 140, a handle 130, and a main body 110. Because the flexible hose 10 can be used with a variety of vacuum cleaners with varying components, components such as the main body 110, the suction port assembly 120, the handle 130, and the extension pipe 140 will be described briefly, but the flexible hose 10 will be described in detail.

Through suction, the suction port assembly 120 may draw in air containing dust from a surface to be cleaned. A suction port 121 may be formed on a bottom surface of the suction port assembly 120 to draw in air. The extension pipe 140 may connect the suction port assembly 120 to the handle 130. The handle 130 may be formed in order that the user can manipulate the suction port assembly 120 by using the handle 130. The flexible hose 10 may connect the handle 130 to the main body 110. Thus, the handle 130 may be arranged between the main body 110 and the suction port assembly 120. The main body 110 may house therein a vacuum motor (not shown) to provide suction, and a dust separating device (not shown) to separate dust from the incoming air.

Thus, air containing dust can be drawn in through the suction port 121 and pass through the extension pipe 140, the handle 130, and the flexible hose 10. A dust separating device (not shown) mounted in the main body 110 separates the dust from the air. Thereafter, the air may be discharged from the main body 110.

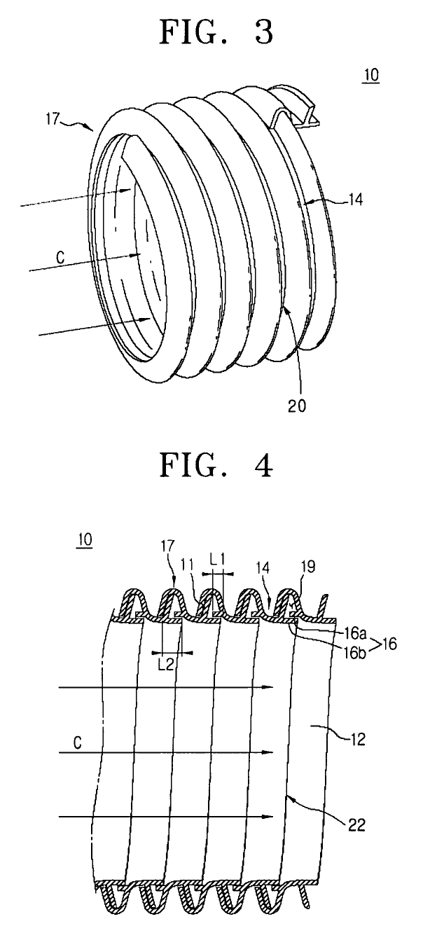

Referring to FIG. 3, the flexible hose 10 according to an exemplary embodiment of the present invention may be implemented with a bellows pipe wall 12 that has a peak 17 that generally curves outward and a valley 14 that generally curves inward and the peaks 17 and valleys 14 alternate in a longitudinal direction. The bellows pipe wall 12 may provide flexibility. The bellows pipe wall 12 may be formed from a largely arched tape of synthetic resin being wound in a spiral form successively with overlapping areas 11 (shown in FIG. 4) that are bonded to each other by an adhesive. Accordingly, a plurality of valleys 14 and a plurality of peaks 17 may be formed on an outer circumferential surface 20 of the bellows pipe wall 12.

Referring to FIG. 4, a plurality of grooves 19 may be formed under the plurality of peaks 17. The plurality of grooves 19 may be formed at an inner circumferential surface 22 of the bellows pipe wall 12. To prevent air from colliding with the plurality of grooves 19, an air barrier 16 may be formed to block air from entering the plurality of grooves 19.

The air barrier 16 is integrally formed with the bellows pipe wall 12 in the exemplary embodiment of the present invention. Alternatively, the air barrier 16 may be provided separately and attached to the bellows pipe wall 12 by any known manner, such as an adhesive. The air barrier 16 may have a first ledge 16a and a second ledge 16b. The first ledge 16a and the second ledge 16b may overlap to prevent air from entering the plurality of grooves 19. The first ledge 16a and the second ledge 16b may extend from the valley 14. The first ledge 16a may extend from the valley 14 in a direction substantially opposite to the flowing direction C of air and may partially cover the groove 19. The second ledge 16b may extend from the valley 14 substantially parallel to the flowing direction C of air and may partially cover the groove 19. The first ledge 16a and the second ledge 16b may overlap so that the second ledge 16b covers the first ledge 16a. When the bellows pipe wall 12 is stretched and the width of the plurality of grooves 19 increases, the sum of a length L1 of the first ledge 16a and a length L2 of the second ledge 16b may be longer than the maximum width of the plurality of grooves 19. Thus, air does not enter the plurality of grooves 19 when the bellows pipe wall 12 is stretched. Accordingly, when the bellows pipe wall 12 expands or contracts as the flexible hose 10 is bent, the air passing through the flexible hose 10 may pass by the bellows pipe wall 12 without colliding against the plurality of grooves 19, and thus, flow noise is reduced.

The second ledges 16b are longer than the first ledges 16a in the exemplary embodiment of the present invention. Alternatively, the second ledge 16b may be shorter than the first ledge 16a so that the second ledge 16b partially covers the first ledge 16a, and the overlapping of the first ledge 16a and second ledge 16b can cover the groove 19.

The first ledge 16a and the second ledge 16b are not integrally formed with each other. If the first ledge 16a and the second ledge 16b were formed as one body instead of at least two overlapping bodies as in the exemplary embodiment of the present invention, the tensile strength and compressibility of the flexible hose 10 would be lowered. High tensile strength and compressibility are characteristics of the flexible hose 10. Thus, lowering the tensile strength and compressibility would also reduce the flexibility of the flexible hose 10. If the flexible hose 10 were bent, the overlapping of the first ledges 16a and the second ledges 16b may adjust to provide the flexibility to bend the flexible hose 10.

An operation of the vacuum cleaner 100 employing the flexible hose 10 according to an exemplary embodiment of the present invention will be described with reference to FIGS. 2 to 5.

When power is applied to a suction motor (not shown) housed in the main body 110, the suction motor generates suction so that the suction port assembly 120 suctions in air containing dust from the surface to be cleaned through the suction port 121. The drawn-in air and dust may pass through the extension pipe 140, the handle 130, and the flexible hose 10. Then, the dust may be separated from the air in the dust separating device (not shown) mounted in the main body 110. The air may then be discharged to the exterior of the main body 110. If air flows in the direction C along the bellows pipe wall 12 of the flexible hose 10 as shown in FIG. 4, the air does not enter the plurality of grooves 19 but instead may flow along the first ledges 16a and the second ledges 16b. As a result, flow noise can be reduced. Additionally, when the flexible hose 10 is bent causing the overlapping of the first ledges 16a and the second ledges 16b to adjust, the plurality of grooves 19 may remain covered by the first ledges 16a and the second ledges 16b, so that air does not enter the plurality of grooves 19.

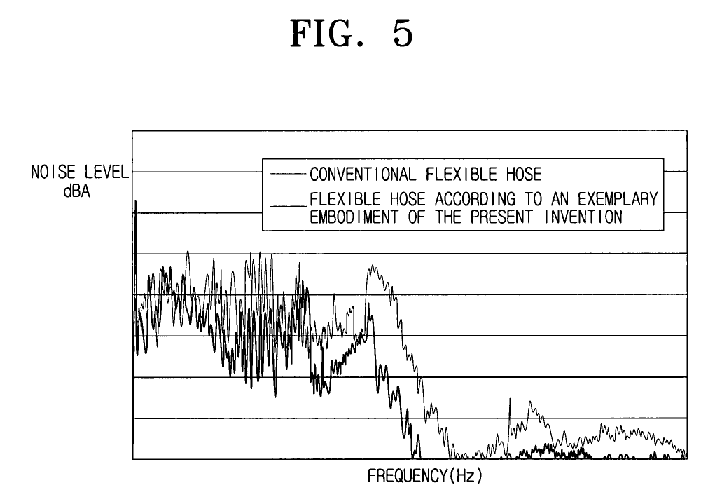

FIG. 5 is a graph plotting test data acquired from experiments to compare noise from the flexible hose 10 according to an exemplary embodiment of the present invention to the noise from a conventional flexible hose. The noise was measured while a vacuum cleaner employed the flexible hose 10 of the present invention and again when the vacuum cleaner used the conventional flexible hose.

Referring to FIG. 5, the noise level (dBA) of the flexible hose 10 can be lower across the entire frequency bandwidth than the conventional flexible hose. Thus, when a user uses the flexible hose 10 according to an exemplary embodiment of the present invention, the noise of the vacuum cleaner can be reduced.

As described above, the flexible hose according to an exemplary embodiment of the present invention prevents air from entering the plurality of grooves in the bellows pipe wall. Accordingly, noise caused by a fluid flowing along the bellows pipe is reduced. As a result, the noise of the vacuum cleaner using the flexible hose can be reduced.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A flexible hose, comprising:
a bellows pipe wall, the bellows pipe wall including,
a plurality of peaks defined on an outer surface of the bellows pipe wall,
a plurality of valleys, each of the plurality of valleys being disposed adjacent a respective peak, and
a plurality of grooves defined on an inner surface of the bellows pipe wall,
each of the plurality of grooves being disposed under a respective peak; and
an air barrier disposed near each of the plurality of grooves configured to prevent air from entering the plurality of grooves.

2. The flexible hose of claim 1, wherein the air barrier is formed integrally with the bellows pipe wall.

3. The flexible hose of claim 1, wherein the air barrier comprises:
a first ledge extending from each of the plurality of valleys to partially cover each of the plurality of grooves; and
a second ledge extending from each of the plurality of valleys opposite the first ledge, the second ledge extending to partially cover each of the plurality of grooves, the second ledge partially overlapping with the first ledge,
wherein the first ledge and the second ledge cover each of the plurality of grooves completely, so that air flowing along the bellows pipe wall does not enter the plurality of grooves.

4. The flexible hose of claim 3, wherein at least one of the first ledge and the second ledge extends in a direction substantially opposite to the air flow direction, and the other ledge extends in a direction substantially parallel to the air flow direction.

5. The flexible hose of claim 3, wherein a sum of a length of the first ledge and a length of the second ledge is longer than a maximum width of each of the plurality of grooves when the bellows pipe wall is stretched.

6. The flexible hose of claim 1, wherein the flexible hose is made of synthetic resin.

7. A vacuum cleaner, comprising:
a suction port assembly for suctioning in air;
a flexible hose with a first end and a second end, the first end being in fluid communication with the suction port assembly, the flexible hose including,
a wall surrounding the air flowing through the flexible hose,
at least one peak disposed at an outer surface of the wall,
at least one valley disposed adjacent to the at least one peak at the wall,
at least one groove disposed at an inner surface of the wall under the at least one peak, and
an air barrier configured to prevent air from entering the at least one groove; and
a main body being in fluid communication with the second end of the flexible hose.

8. The vacuum cleaner of the claim 7, wherein the air barrier comprises:
a first ledge extending from the at least one valley in a direction substantially opposite to the air flow direction, the first ledge partially covering the at least one groove; and
a second ledge extending from the at least one valley in a direction substantially parallel to the air flow direction, the second ledge partially covering the at least one groove and overlapping with the first ledge,
wherein the first ledge and the second ledge cover the at least one groove completely so that the air flowing through the flexible hose does not enter the at least one groove.

9. The vacuum cleaner of claim 7, wherein a sum of a length of the first ledge and a length of the second ledge is longer than a maximum width of the at least one groove when the wall is stretched.

10. The vacuum cleaner of claim 7, further comprising a handle disposed between the suction port assembly and the flexible hose.

11. The vacuum cleaner of claim 7, further comprising an extension pipe disposed between the suction port assembly and the flexible hose.

12. The vacuum cleaner of claim 7, wherein the flexible hose is made of synthetic resin.

13. A flexible hose, comprising:
a wall surrounding a fluid flowing through the flexible hose;
at least one peak disposed at an outer surface of the wall;
at least one valley disposed adjacent the at least one peak at the outer surface of the wall;
at least one groove disposed at the inner surface of the wall under the at least one peak; and
an air barrier including,
a first ledge disposed adjacent to the at least one groove, the first ledge extending over the at least one groove in a direction substantially opposite to the flow direction, the first ledge partially covering the at least one groove, and
a second ledge disposed adjacent to the at least one groove opposite the first ledge, the second ledge extending over the at least one groove in a direction substantially parallel to the flow direction, the second ledge partially covering the at least one groove, the second ledge partially overlapping the first ledge,
wherein the first ledge and the second ledge cover the at least one groove completely preventing the fluid flowing through the flexible hose from entering the at least one groove.

14. The flexible hose of claim 13, wherein the first ledge and the second ledge continue to overlap when the wall is longitudinally stretched.

15. The flexible hose of claim 13, wherein the wall is made of synthetic resin.
